(19) United States
(12) Patent Application Publication
(10) Pub. No.: US 2011/0031799 A1
(43) Pub. Date: Feb. 10, 2011

(54) Passenger head support

(76) Inventor: Theri DeJoode, Milwaukee, WI (US)

Correspondence Address: BOYLE FREDRICKSON S.C., 840 North Plankinton Avenue, MILWAUKEE, WI, 53203, US

(21) Appl. No.: 12/846,375

(22) Filed: Jul. 29, 2010

Related U.S. Application Data
(60) Provisional application No. 61/232,244, filed on Aug. 7, 2009.

(51) Int. Cl. B60N 2/48

(52) U.S. Cl. 297/464

(57) ABSTRACT

A head restraint assisting a sleeping or resting passenger may provide for a pleated fabric hammock portion supported by the back of the seat by a retaining strap, the tensioned hammock portion cradling the user's head and/or face.

### CROSS REFERENCE TO RELATED APPLICATION

This application claims the benefit of U.S. Provisional Application No. Provisional application 61/232,244 filed Aug. 7, 2009 or by incorporated by reference in their entireties.

### BACKGROUND OF THE INVENTION

The present invention relates to head restraint devices for sleeping or resting passengers.

For most people, it is difficult to rest or sleep during a long trip as a passenger on aircraft or other transportation. The principal problem is the inability to properly support ones head as sleep falls and muscle tension is lost. If some support for one's head is found, for example against a bulwark or the like, an unnatural head angle may result risking strain or soreness to the passenger's neck.

Numerous approaches have been developed to address these problems. A wraparound neck pillow is generally known to provide head support against the user's shoulders. An alternative approach, shown for example in U.S. Pat. Nos. 6,266,825 and 6,607,245, provide head straps fitting about the passenger's forehead to support the head against an upright seatback.

### SUMMARY OF THE INVENTION

The present invention replaces a narrow head strap used to support the passenger's head against the seat with a fabric hammock which provides a broader area of support, reducing pressure against the user's forehead, and a support which better conforms to the face area. By gathering the fabric in loose pleats, the user may adopt a variety of different support positions using the hammock, varying the area and location of support for better comfort. The fabric may provide a loose weave permitting the hammock to fully envelope the face without restricting breathing and may be of a dark color to block light when covering the eyes.

Specifically, the present invention provides a head restraint for use by a passenger sitting in a seat having a generally upward cantilevered seatback. The head restraint includes a woven fabric panel gathered at opposite ends to bundles, the fabric panel thereby forming a hammock sized to cradle at least a portion of a front of a user's head when the fabric panel is stretched horizontally with the bundles at points near a left and right side of the seatback over the user's head supported by the seatback. An adjustable strap is attached at either end to the bundles and is sized to fit around a back of the upward cantilevered seatback to apply a tension to the woven fabric panel positioned at the front of the cantilevered seatback to stretch the fabric panel horizontally with ends of the adjustable strap supporting the bundled points at left and right sides of the seatback when the user's head is supported by the seatback covered by the hammock.

It is thus a feature of at least one embodiment of the invention to provide a little bulk head support system that distributes the force of supporting a user's head over a broad area that may be flexibly changed to cover and cradle different portions of the user's face.

The fabric panel before pleating and bundling may have a length measured along an axis between the bundled points no more than twice a height measured perpendicularly to the length or a height substantially equal to the length.

It is thus a feature of a least one embodiment of the invention to provide a hammock that can be expanded to fully cover a user's face thereby reducing the pressure on any portion of the user's face.

The fabric panel may be pleated and the bundles may be collapsed pleats folded over themselves and hemmed therethrough to provide a loop.

It is thus a feature of at least one embodiment of the invention to provide a simple termination for the hammock configuration that also promotes a simple and compact packaging of the head restraint by tension on the bundled points which causes a refolding of the pleats.

The adjustable strap may include a ring fitting within the loop.

It is thus a feature of at least one embodiment of the invention to provide a simple interface with a strap material.

The adjustable strap may include a releasable catch positioned near at least one bundle.

It is thus a feature of at least one embodiment of the invention to permit simple connection and disconnection of the head restraint.

The adjustable strap may include a buckle permitting adjustment of the length of the adjustable strap.

It is thus a feature of at least one embodiment of the invention to provide a simple method of length adjustment of the strap suitable for implementation in polymeric material.

The catches, buckle, and ring are polymer materials.

It is thus a feature of at least one embodiment of the invention to provide a design that can be readily transported through airline security systems.

The woven fabric may be substantially opaque.

It is thus a feature of at least one embodiment of the invention to permit the head restraint to work as a sleep aid by blocking light to the user's eyes.

The woven fabric may be black.

It is thus a feature of at least one embodiment of the invention to augment the light absorbing capabilities of a loosely woven fabric, that permits respiration, to provide light blocking.

The fabric may be loosely woven permitting respiration through the fabric.

It is thus a feature of the least one embodiment of the invention permit an over-the-face support of the user's head.

These particular features and advantages may apply to only some embodiments falling within the claims and thus do not define the scope of the invention.

### BRIEF DESCRIPTION OF THE FIGURES

FIG. 1 is a front elevational view of the head restraint of the present invention showing a pleated fabric hammock attached to a retaining strap assembly;

FIG. 2 cross-sectional view along line 2-2 of FIG. 1 showing expanded pleats forming the fabric hammock near a center of the hammock;

FIG. 3 is a figure similar to that of FIG. 2 showing the compressed pleats formed into a loop at opposite ends of the hammock;

FIG. 4 is a fragmentary top view of the head restraint of FIG. 1 showing threading of a strap through buckles, connectors, and rings to form the retaining strap assembly; and

FIGS. 5a-5c are perspective views of a passenger with the hammock in the first, second and third configuration.

### DETAILED DESCRIPTION OF THE PREFERRED EMBODIMENT

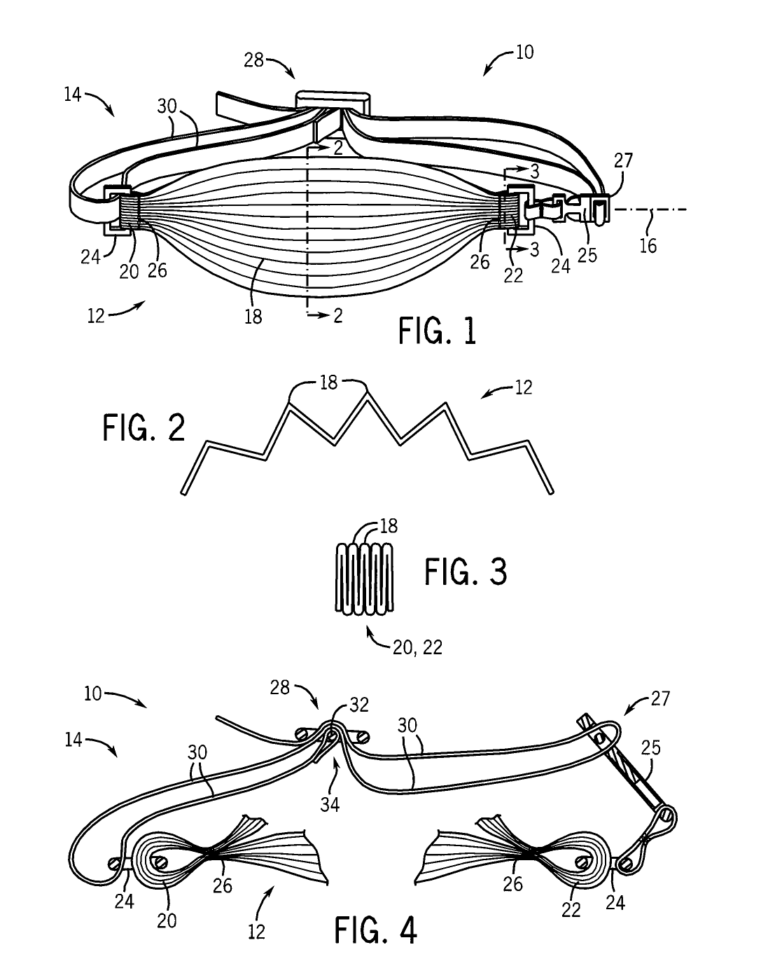

Referring now to FIG. 1, a head support 10 of the present invention includes a hammock portion 12 and a retaining strap assembly 14.

The hammock portion 12 may consist of a loosely woven cotton fabric extending generally along a horizontal axis 16 and formed into pleats 18 along the axis 16 and gathered at end bundles 20 and 22. The fabric of the hammock portion 12 when laid flat, before pleating and bundling, may be approximately a square and will generally have a length measured along an axis between the bundled points no more than twice a height measured perpendicularly to the length along axis 16 to provide an adequately sized hammock. The fabric will generally be loosely woven to permit respiration therethrough and of dark or black color to block light transmission through the fabric.

The end bundles 20 and 22 are folded back on themselves along axis 16 and have stitches 26 across the folded back portion to provide loops about corresponding plastic rings 24.

The retaining strap assembly 14 may be a nylon strap 30 passing behind the hammock portion 12 and looping around the ring 24 at the left bundle 20 of the hammock portion 12 and at the right bundle 22 of the hammock portion 12 attached to a snap clip 25 by means of the buckle end 27 of the snap clip 25, the buckle end 27 receiving a second loop of the nylon strap 30. The snap clip 25 may be a polymer two-part clip of a type well known in the art manually releasable by the inward pressing of engaging teeth and may be joined by a short nylon loop 29 to ring 24 of bundle 22. The free ends of the nylon strap 30 may be adjustably held together by means of a polymer bisected ring buckle 28 as will be described below.

Referring now to FIG. 2, generally the pleats 18 in the center of a hammock portion may be expanded to provide a concave surface to cradle the user's head as will be described below.

Referring to FIG. 3, these pleats 18 may be fully compressed at the bundles 20 and 22 to provide a relatively compact strap that may be folded and stitched with stitches 26. The collection of the pleats at bundles 20 and 22 permits even force to be applied to the ends of the hammock portion 12 by tension at the rings 24.

Referring now to FIG. 4, a first portion of the nylon strap 30 may be attached to a center post 32 of a bisected ring buckle 28 by a stitched loop 34. The nylon strap 30 may then pass through ring 24 from a rear of the hammock portion 12 and back rearward through a first section of the bisected ring buckle 28 and then frontward through opposite second section of the bisected ring buckle 28 to then pass through the buckle end 27 of the retaining snap clip 25 and then back rearward through the second section of the bisected ring buckle 28 and then forward through the first section of the bisected ring buckle 28 to provide an adjustable cinching allowing the length of the retaining strap assembly 14 to be adjusted to adjust the tension on the hammock portion 12 as will now be described.

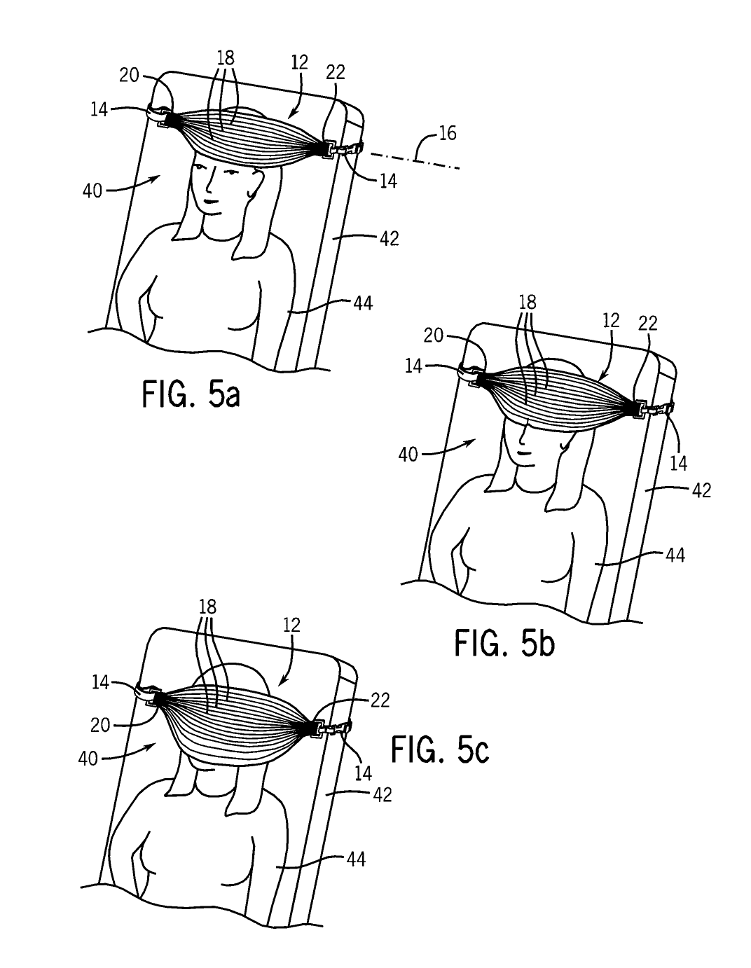

Referring now to FIG. 5a-5c, the retaining strap assembly 14 may be positioned to circle behind an upward cantilevered seatback 42, for example, in a train or airplane to hold the hammock portion 12 in light tension toward the front of the seatback 42. The tension may be applied to the bundles 20 and 22 positioned at the left and right sides of the seatback 42 with the horizontal axis 16 positioned at the head height of the seated passenger 44. In a first configuration, the hammock portion 12 may be positioned to conform to the front upper part of the passenger's head 40 free from the passenger's eyes to provide gentle support over the broad surface of the passenger's upper head and brow. Referring now to FIG. 5b, in a second configuration, the pleats 18 may be spread to bring a lower edge of the hammock portion 12 down over the passenger's eyes to block light to provide a more restful experience. Referring now to FIG. 5c, facial pressure points may be substantially reduced by expanding the pleats 18 further to cover the full face of the passenger with the hammock portion 12.

It will be understood that the nylon strap 30 does not contact a passenger's skin directly, but only the woven material of the hammock portion 12 that by nature of the weave will better conform to the complex surface of the passenger's face and head.

When the user is through with using the head support 10, it may be stored in a drawstring bag by pulling on the straps to fold the pleats and rolling it up along the folded length.

In one embodiment, an elastic member, for example, a bungee cord or elastic strap may be placed between the plastic ring 24 and the nylon strap 30 so as to provide a spring biasing of the hammock portion 12 against the passenger's head 40 sufficient to hold the passenger's head in position during rest, but flexible enough to allow free movement forward of the passenger's head 40 in the event of a crash, for example, when the invention is used in an automobile, allowing the automobile's intended restraint devices to operate appropriately. Such elasticity or a frangible or breakaway element may be incorporated anywhere into the restraining elements of the device.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. A head restraint for use by a passenger sitting in a seat having a generally upward cantilevered seatback, the head restraint comprising:
a woven fabric panel gathered at opposite ends to bundles, the fabric panel thereby forming a hammock sized to cradle at least a portion of a front of a user's head when the fabric panel is stretched horizontally with the bundles at points near a left and right side of the seatback over the user's head supported by the seatback; and
an adjustable strap attached at either end to the bundles and sized to fit around a back of the upward cantilevered seatback to apply a tension to the woven fabric panel positioned at the front of the cantilevered seatback to stretch the fabric panel horizontally with ends of the adjustable strap supporting the bundles at left and right sides of the seatback when the user's head is supported by the seatback covered by the hammock.

2. The head restraint of claim 1 wherein the fabric panel before pleating and bundling has a length measured along an axis between the bundled points no more than twice a height measured perpendicularly to the length.

3. The head restraint of claim 2 wherein the fabric panel before pleading and bundling has a length measured along an axis between the bundled points substantially equal to a height measured perpendicularly to the length.

4. The head restraint of claim 1 wherein the fabric panel is pleated and the bundles are collapsed pleats folded over themselves and hemmed therethrough to provide a loop.

5. The head restraint of claim 4 wherein the adjustable strap includes a ring fitting within the loop.

6. The head restraint of claim 5 wherein the adjustable strap includes a releasable catch positioned proximate at least one bundle.

7. The head restraint of claim 6 wherein the adjustable strap includes a buckle permitting adjustment of a length of the adjustable strap.

8. The head restraint of claim 7 wherein the catch, buckle, and rings are polymer materials.

9. The head restraint of claim 1 wherein the woven fabric is substantially opaque.

10. The head restraint of claim 1 wherein the woven fabric is black.

11. The head restraint of claim 1 wherein the fabric is loosely woven permitting respiration through the fabric.
